(19) United States
(12) Patent Application Publication
(10) Pub. No.: US 2005/0055898 A1
(43) Pub. Date: Mar. 17, 2005

(54) Guard for swimming pool skimmers

(76) Inventors: Alan Georgeff, Newbury Park, CA (US); Louis Leonard Papera, Newbury Park, CA (US)

Correspondence Address: Dennis H. Lambert & Associates, 7000 View Park Drive, Burke, VA, 22015, US

(21) Appl. No.: 10/660,961

(22) Filed: Sep. 12, 2003

(51) Int. Cl. E06B 5/02

(52) U.S. Cl. 52/169.6

(57) ABSTRACT

A guard for placement in front of, or across, a swimming pool skimmer opening to prevent leaves and other floating debris from entering the skimmer opening. The guard is an elongate body of open mesh-like material having fastening tabs on opposite ends for attachment of the body across the swimming pool skimmer opening, and traps leaves and other floating debris to prevent the debris from entering the skimmer opening.

### TECHNICAL FIELD

This invention relates to swimming pool skimmers, and more particularly to a simple and inexpensive guard that is placed in front of the skimmer to intercept leaves and other debris.

### BACKGROUND ART

Water in swimming pools is circulated by a pump through one or more inlets into the pool and through one or more outlets from the pool. The outlets include outlets located at the waterline around the periphery of the pool. These outlets are commonly referred to as skimmers, and serve to return water to the pump inlet as well as to trap or skim leaves and other floating debris from the water as it enters the skimmers.

If an excessive amount of debris becomes trapped in the skimmers, undue strain is placed on the pump, shortening its life. Accordingly, it is important to frequently inspect and clean the skimmers, especially if there are trees or other sources of floating debris near the pool. Failure to frequently clean the skimmers can result in damage to the pump, necessitating expensive repair, or at the very least can reduce the rate of circulation of water in the pool and thereby reduce the effectiveness of the filtration system and/or result in a chemical imbalance in the pool water.

Accordingly, there is need for a system to minimize or eliminate clogging of swimming pool skimmers without requiring frequent inspection and cleaning of the skimmers.

### DISCLOSURE OF THE INVENTION

The present invention comprises a strainer or guard that is placed in front of a swimming pool skimmer to trap leaves and other floating debris before it enters the skimmer, thereby minimizing or eliminating clogging of the skimmer without requiring frequent inspection and cleaning of the skimmer.

The strainer or guard is formed of an open, mesh-like material that projects above and below water level and extends in outwardly spaced relationship to the skimmer. It is open at least at its bottom and functions to pass water while trapping leaves and other floating debris. Since the skimmer remains free of debris, and the water level in the space between the guard and skimmer is independent of the amount of debris trapped in front of the guard, water is always available to flow at its normal rate through the skimmer, regardless of the amount of debris that might be trapped in front of the guard.

Preferably, the skimmer guard is simple and inexpensive to manufacture, is adjustable to fit different size and style skimmers, and is easy to apply and remove

### BRIEF DESCRIPTION OF THE DRAWINGS

The foregoing as well as other objects and advantages of the invention will become apparent from the following detailed description when considered in conjunction with the accompanying drawings, wherein like reference characters designate like parts throughout the several views, and wherein:

FIG. 1 is a top perspective view of a portion of a swimming pool showing the skimmer guard of the invention in place in front of a skimmer.

FIG. 2 is a side view in elevation of the skimmer guard of the invention in operative position in front of a swimming pool skimmer.

FIG. 3 is a perspective view of the skimmer guard of the invention in its as-manufactured, flat condition.

FIG. 4 is a perspective view of the skimmer guard of the invention in a shaped, bent condition preparatory to attaching it in front of a skimmer.

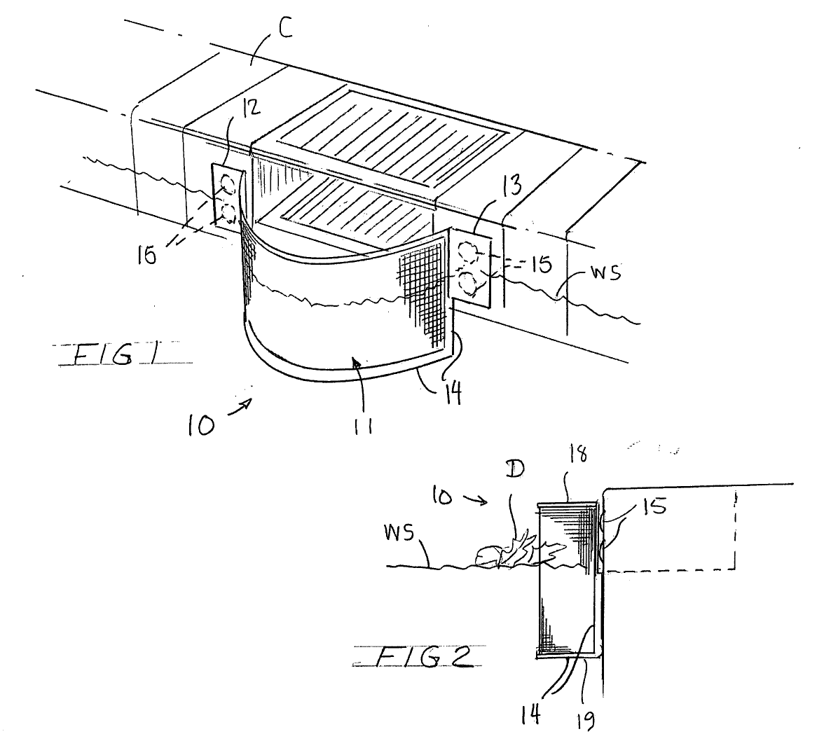

### DETAILED DESCRIPTION OF THE PREFERRED EMBODIMENTS

A skimmer guard according to the invention is shown at 10 in the drawings. The skimmer guard preferably is injection-molded as one piece from a plastic material that is compatible with a swimming pool environment, e.g., able to withstand the effects of swimming pool chemicals, sunlight, etc. Such materials are commercially available and are commonly used to make strainers and other components of swimming pool equipment.

As shown in FIG. 3, the skimmer guard is manufactured as a flat, rectangular body 11 having outwardly projecting tabs 12 and 13 on its opposite ends. The body 11 preferably is about 30 inches long and 15 inches high, and comprises an open mesh-like structure, with a reinforcing frame portion 14 extending around it. At least one, and preferably two, suction cups 15 are carried by the tabs 12 and 13 for attaching the skimmer guard to the wall of the swimming pool. The suction cups may be of the type commonly used, for example, to attach soap holders and the like to the wall of a shower stall.

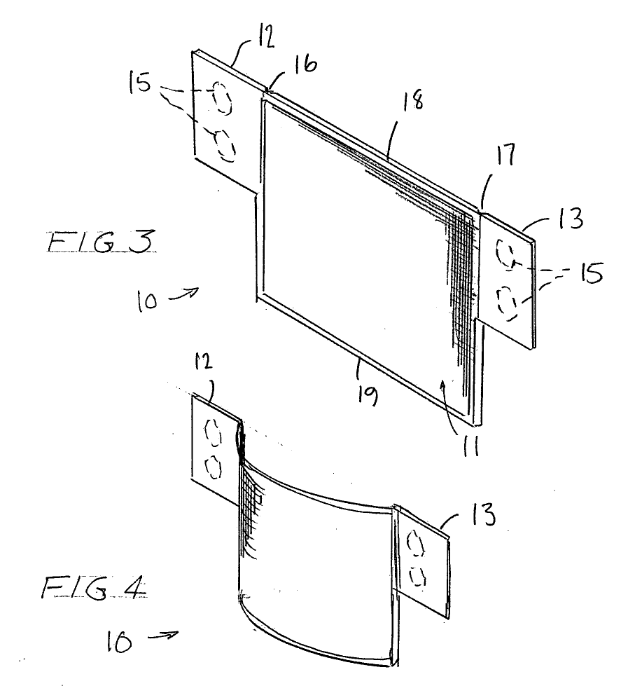

In use, the guard is flexed into an arcuate shape, as indicated in FIG. 4, with the tabs 12 and 13 bent or flexed laterally outwardly. To facilitate flexing of the tabs, they may be joined to the body 11 by living hinges 16 and 17. The extent of flexing of the guard accommodates the guard to different size skimmers, i.e., only slight flexing leaves the guard relatively long for placement over wide skimmer openings, and greater flexing results in a guard having shorter length. Of course, the guard need not be flexed so that its length exactly matches the width of the skimmer opening, and it need not be flexed at all, so long as the guard is at least as wide as the opening. The flexed guard is then positioned across the skimmer opening, with its upper and lower edges 18 and 19 spaced approximately equidistantly above and below the surface WS of the water, and the tabs located on opposite sides of the skimmer opening. The suction cups are then pressed against the wall of the pool to attach the guard in position in front of the skimmer opening. As shown in FIG. 1, the suction cups are attached to the coping C. Debris D floating on the water will then be trapped in front of the skimmer guard and will not enter the skimmer opening.

Since the skimmer guard is open at its bottom, the water level between the guard and the skimmer is independent of the ability of the mesh-like body 11 to pass water through it. Thus, proper functioning of the invention and of the skimmer does not rely upon keeping debris from in front of the guard. Moreover, the guard keeps debris from entering the skimmer, whereby there is little risk of clogging of the skimmer itself.

Although particular embodiments of the invention are illustrated and described in detail herein, it is to be understood that various changes and modifications may be made to the invention without departing from the spirit and intent of the invention as defined by the scope of the appended claims.

### AMENDMENT OF THE SPECIFICATION

Please amend the Disclosure of the Invention as originally filed with the following re-written Disclosure of the Invention:

### DISCLOSURE OF THE INVENTION

The present invention comprises a strainer or guard that is placed in front of a swimming pool skimmer to trap leaves and other floating debris before it enters the skimmer, thereby minimizing or eliminating clogging of the skimmer without requiring frequent inspection and cleaning of the skimmer.

The strainer or guard is formed of an open, mesh or mesh-like material that projects above and below water level and extends in outwardly spaced relationship to the skimmer. It is open at least at its bottom and functions to pass water while trapping leaves and other floating debris. Since the skimmer remains free of debris, and the water level in the space between the guard and skimmer is independent of the amount of debris trapped in front of the guard, water is always available to flow at its normal rate through the skimmer, regardless of the amount of debris that might be trapped in front of the guard.

Preferably, the skimmer guard is simple and inexpensive to manufacture, is adjustable to fit different size and style skimmers, and is easy to apply and remove.

1. A guard for placement in front of a swimming pool skimmer opening to prevent leaves and other floating debris from entering the skimmer opening, comprising:
an elongate body of open mesh material having attaching means thereon for attachment of the body across a swimming pool skimmer opening, said body being adjustable to fit different size skimmer openings, and functioning to trap floating debris and prevent the debris from entering the skimmer opening.

2. (cancelled)

3. A guard as claimed in claim 1, wherein:
the guard is flexible, and is bendable into an arcuate shape that enables the length of the guard to be shortened or lengthened, thereby adjusting the guard to fit different size skimmer openings.

4. A guard as claimed in claim 3, wherein:
the guard is made in one piece from a plastic material.

5. A guard as claimed in claim 4, wherein:
the attaching means comprises at least one suction cup at each end of the guard.

6. A guard as claimed in claim 5, wherein:
the attaching means further comprises a tab on each end of the elongate body, said at least one suction cup being carried by the tabs.

7. A guard as claimed in claim 6, wherein:
the tabs are each joined to the body by a living hinge, whereby the tabs are easily flexed to lie parallel to a surface of a swimming pool to which the guard is to be attached.

8. A guard s claimed in claim 7, wherein:
the guard is about thirty inches long and fifteen inches high.
